(19) United States
(12) Patent Application Publication
(10) Pub. No.: US 2007/0109313 A1
(43) Pub. Date: May 17, 2007

(54) Image processing apparatus and image processing method

(75) Inventor: Gye-wook Jo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/591,468

(22) Filed: Nov. 2, 2006

(30) Foreign Application Priority Data
Nov. 17, 2005 (KR) 2005-0110168

(51) Int. Cl. G09G 5/02

(52) U.S. Cl. 345/589; 345/646

(57) ABSTRACT

An image processing apparatus and a method thereof are provided. The image processing apparatus including a signal input unit to which an analog image signal is inputted, includes a first conversion unit for converting the analog image signal inputted through the signal input unit into a first digital image signal, a calculating unit for calculating a gray scale mean for an image by analyzing a brightness signal of the first digital image signal outputted from the first conversion unit and outputting a gray scale mean signal corresponding to the calculated gray scale mean, at least one second conversion unit for converting a portion of the analog image signal into a second digital image signal based on the gray scale mean signal, and a combining unit for combining the first digital image signal and the second digital image signal based on the gray scale mean signal. Accordingly, an improved gray scale representation signal can be provided by performing an adaptive process to convert an analog image signal into a digital image in consideration of gray scales of the analog image signal.

### CROSS-REFERENCE TO RELATED APPLICATIONS

This application claims the benefit under 35 U.S.C.§ 119(a) of Korean Patent Application No. 2005-0110168, filed on Nov. 17, 2005, the entire disclosure of which is hereby incorporated by reference.

### BACKGROUND OF INVENTION

1. Field of Invention:

The present invention relates to an image processing apparatus. More particularly, the present invention relates to an image processing apparatus and a method thereof for converting an analog image signal into a digital image signal.

2. Description of the Related Art:

An image processing apparatus generally includes an image signal processing unit for processing various inputted image signals. In particular, a display device employing such an image processing apparatus includes a signal input unit for receiving an external image signal, an image signal processing unit for processing the image signal received through the signal input unit, and a display unit for displaying the image signal outputted from the image signal processing unit as an image. The image signal received from the signal input unit is processed in the image signal processing unit to be displayed on the display unit as an image.

Hereinafter, a display device employing a conventional image processing apparatus will be described with reference to FIG. 1. The display device includes an ADC (analog-to-digital converter) 1 for converting an analog image signal inputted through a signal input unit into a digital image signal, a comb filter 2 for separating the digital image signal from the ADC 1 into a brightness signal and a color difference signal, a decoder 3 for decoding the brightness signal and the color difference signal from the comb filter 2, and an image signal processing unit 4 for processing the image signal outputted from the decoder 3 into a displayable format on the display unit 6. Here, the display device employing the conventional image processing apparatus may further include an image enhancement unit 5 for performing an enhancing process to improve the image quality of an image signal processed in the image signal processing unit 4 before displaying the image signal processed in the image signal processing unit 4 on the display unit 6.

Now, the image enhancement unit 5 will be described in more detail with reference to FIG. 2. The image enhancement unit 5 includes a histogram analyzer 7 for analyzing a brightness signal of the image signal in a digital format, which is outputted from the image signal processing unit 4, to calculate the gray scale mean for an image, a CE (contrast enhancer) functional unit 8 for adjusting contrast of the image signal based on the gray scale mean calculated in the histogram analyzer 7, and a BWS (black & white stretch) functional unit 9 for adjusting a black component of the image signal based on the gray scale mean calculated in the histogram analyzer 7. In this manner, the display device employing such a conventional image processing apparatus further includes the image enhancement unit 5 for performing the enhancing process to adjust the contrast and the black component to improve the image quality of the image signal processed in the image signal processing unit 4, thereby displaying a high quality image corresponding to the inputted analog image signal.

As stated above, in the image processing apparatus for receiving the analog image signal and outputting an image corresponding to the received analog image signal, the ADC 1 is indispensable for converting the analog image signal into the digital image signal. In displaying an image in the conventional image processing apparatus, the ADC 1 has a great influence on a variety of performances such as noise and gradation representation. For example, in case where the ADC 1 provided in a leading stage of the process for processing an analog image signal has a low performance with 8-bit, deterioration of quality of the image signal to be outputted cannot be avoided even though the comb filter 2, the decoder 3, and the image signal processing unit 4 are high-performance functional units capable of processing data of more than 8-bit. The deterioration of the image quality will be distinctly perceptible when the image signal with a low gray scale is outputted.

In other words, a problem exists in the conventional image processing apparatus in that the limitation of gray scale representation cannot be solved for the image signal to be outputted, even though the functional units provided in the latter stage of signal process have excellent performance.

Accordingly, there is a need for an improved image processing apparatus and method that provides an improved gray scale representation signal.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image processing apparatus and a method thereof for providing improved gray scale representation signal by performing an adaptive process to convert an analog image signal into a digital image in consideration of gray scales of the analog image signal.

The foregoing and/or other aspects of exemplary embodiments of the present invention can be achieved by providing an image signal processing apparatus including a signal input unit to which an analog image signal is inputted, in which a first conversion unit converts the analog image signal inputted through the signal input unit into a first digital image signal; a calculating unit calculates a gray scale mean for an image by analyzing a brightness signal of the first digital image signal outputted from the first conversion unit, and outputs a gray scale mean signal corresponding to the calculated gray scale mean; at least one second conversion unit converts a portion of the analog image signal into a second digital image signal based on the gray scale mean signal; and a combining unit combines the first digital image signal and the second digital image signal based on the gray scale mean signal.

In an exemplary implementation, the image processing apparatus further includes a filtering unit for receiving the first digital image signal outputted from the first conversion unit and the second digital image signal outputted from the second conversion unit and separating each of the received first and second digital image signals into a brightness signal and a color difference signal.

In another exemplary implementation, the calculating unit calculates the gray scale mean for the image by analyzing the brightness signal, which corresponds to the first digital image signal, of the brightness signal and the color difference signal in each of the first and second digital image signals outputted from the filtering unit, and outputs the gray scale mean signal corresponding to the calculated gray scale mean.

In still another exemplary implementation, the calculating unit calculates a total gray scale value by adding up gray scale values for gray scale representation expressing the image, based on the brightness signal of the first digital image signal, and calculates the gray scale mean by dividing the total gray scale values by the number of represented gray scales of the image.

In a further exemplary implementation, the at least one second conversion unit converts a portion of the analog image signal inputted through the signal input unit, the portion corresponding to the luminance lower than the gray scale mean, into the second digital image signal, based on the gray scale mean signal.

In an exemplary implementation, the combining unit includes a dithering unit for performing a dithering process for predetermined data in the brightness signal of the second digital image signal based on the gray scale mean signal, and a mixer for combining a portion of the brightness signal of the first digital image signal, the portion corresponding to the luminance higher than the gray scale mean, with the brightness signal of the second digital image signal outputted from the dithering unit based on the gray scale mean signal and a predetermined look-up table.

In another exemplary implementation, the image processing apparatus further includes a signal processing unit for processing the color difference signal corresponding to the first digital image signal outputted from the filtering unit and the brightness signal outputted from the combining unit into a displayable image signal; and an image enhancement unit for improving image quality of an image signal outputted from the signal processing unit.

In still another exemplary implementation, the image enhancement unit performs a process for improving the image quality of the image signal outputted from the signal processing unit based on the gray scale mean signal outputted from the calculating unit.

In a further exemplary implementation, the image enhancement unit comprises a contrast enhancer (CE) functional unit for adjusting contrast of the image signal outputted from the signal processing unit based on the gray scale mean signal, and a black & white stretch (BWS) functional unit for adjusting a black component of the image signal.

In an exemplary implementation, each of the first conversion unit and the second conversion unit comprises an analog-to-digital converter (ADC) for converting an analog image signal into a digital image signal.

In another exemplary implementation, the image processing apparatus further includes a display unit for displaying an image according to the digital image signal outputted from the combining unit.

The foregoing and/or other aspects of exemplary embodiments of the present invention can be also achieved by providing an image processing method for an image signal processing apparatus including a signal input unit to which an analog image signal is inputted, the method including converting the analog image signal inputted through the signal input unit into a first digital image signal; calculating a gray scale mean for an image by analyzing a brightness signal of the first digital image signal, and outputting a gray scale mean signal corresponding to the calculated gray-scale mean; converting a portion of the analog image signal inputted through the signal input unit into a second digital image signal based on the gray scale mean signal; and combining the first digital image signal and the second digital image signal based on the gray scale mean signal.

In an exemplary implementation, the image processing method further includes separating the first digital image signal into a brightness signal and a color difference signal; and separating the second digital image signal into a brightness signal and a color difference signal.

In another exemplary implementation, the outputting of the gray scale mean includes calculating a total gray scale value by adding up gray scale values for gray scale representation expressing the image, based on the brightness signal of the first digital image signal; calculating the gray scale mean by dividing the total gray scale values by the number of represented gray scales of the image; and outputting the calculated gray scale mean signal.

In still another exemplary implementation, the converting of the portion of the analog image signal into the second digital image signal includes converting a portion of the analog image signal inputted through the signal input unit, the portion corresponding to the luminance lower than the gray scale mean, into the second digital image signal, based on the gray scale mean signal.

In a further exemplary implementation, the combining of the first digital image signal and the second digital image signal includes performing a dithering process for predetermined data in the brightness signal of the second digital image signal based on the gray scale mean signal; and combining a portion of the brightness signal of the first digital image signal, the portion corresponding to the luminance higher than the gray scale mean, with the brightness signal of the dithered second digital image signal based on the gray scale mean signal and a predetermined look-up table.

In an exemplary implementation, the image processing method further includes processing the color difference signal separated from the first digital image signal and a mixed brightness signal produced by a mixture of the brightness signal of the first digital image signal and the brightness signal of the second digital image signal into a displayable image signal; and improving image quality of the displayable image's image signal.

In another exemplary implementation, the improving of the image quality of the displayable image's image signal includes improving the image quality of the displayable image signal based on the gray scale mean signal.

In still another exemplary implementation, the improving of the image quality of the displayable image includes adjusting contrast of the displayable image signal based on the gray scale mean signal; and adjusting a black component of the displayable image signal.

In a further exemplary implementation, the image processing method further includes displaying an image according to a mixed digital image signal produced by a mixture of the first digital image signal and the second digital signal.

### BRIEF DESCRIPTION OF THE DRAWINGS

The above and other objects, features and advantages of certain exemplary embodiments of the prevent invention will be more apparent from the following description taken in conjunction with the accompany drawings, in which:

FIG. 1 is a control block diagram of a display device employing a conventional image processing apparatus;

FIG. 2 is a detailed control block diagram of an image enhancement unit in the display device as shown in FIG. 1;

FIGS. 3 and 4 are control block diagrams of a display device to which an image processing apparatus according to an exemplary embodiment of the present invention is applied;

FIGS. 5(a)-5(c) are exemplary diagrams illustrating an image processing apparatus according to an exemplary embodiment of the present invention; and

FIG. 6 is a control flow chart illustrating an image processing method according to an exemplary embodiment of the present invention.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, the present invention will be described in detail with reference to the accompanying drawings.

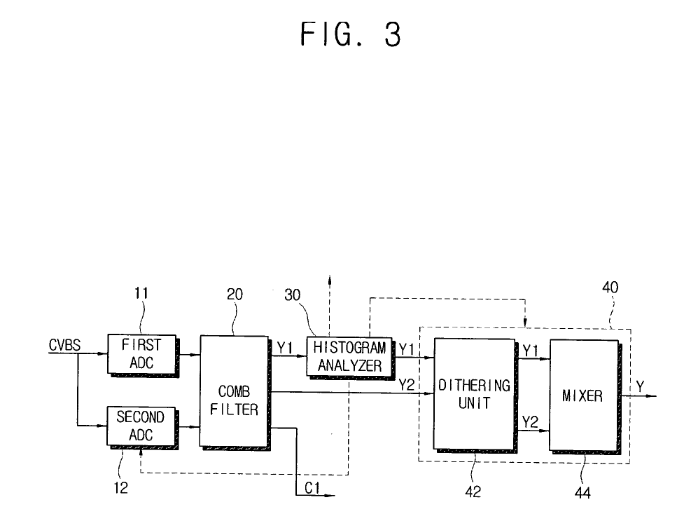

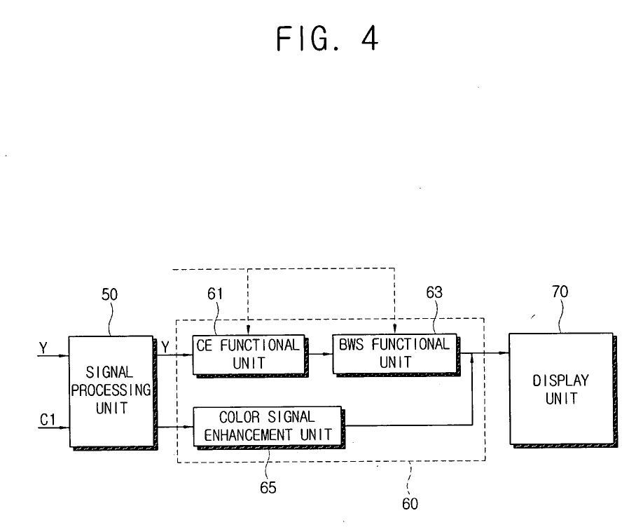

FIGS. 3 and 4 are control block diagrams of a display device employing an image processing apparatus according to an exemplary embodiment of the present invention. Referring to FIG. 3, the display device includes first and second analog-to-digital converters (ADCs) 11 and 12 for converting an analog image signal (for example, composite video baseband signal (CVBS)) provided through a signal input unit (not shown) inputted with an analog image signal into a digital image signal, a comb filter 20, a histogram analyzer 30, and a combining unit 40. Furthermore, FIG. 4 illustrates a signal processing unit 50 for processing an image signal outputted from the combining unit 40 and the comb filter 20 as shown in FIG. 3, an image enhancement unit 60, and a display unit 70.

The first ADC 11 is a first conversion unit for converting the inputted analog image signal into a digital image signal. The first ADC 11 converts the whole analog image signal corresponding to the whole gray scale of the inputted analog image signal into the digital image signal. For example, if the first ADC 11 has the performance of 8-bit processing, the first ADC 11 converts the whole analog image signal corresponding to 0˜255 gray scales into a digital image signal.

The second ADC 12 is a second conversion unit for converting the inputted analog image signal into a digital image signal. The second ADC 12 converts a portion of the inputted analog image signal into a digital image signal based on a gray scale mean signal outputted from the histogram analyzer 30. Specifically, the second ADC 12 receives the analog image signal as in the first ADC 11, and converts a portion of the analog image signal, which corresponds to the luminance lower than the gray scale mean, into a digital image signal, based on the gray scale mean signal. For example, if the second ADC 12 has the performance of 8-bit processing, the second ADC 12 supports a portion of the analog image signal corresponding to a range of from 0 to a gray scale mean value (Y_Mean) into a digital image signal. Such conversion of a portion of the inputted analog image signal, which corresponds to the luminance lower than the gray scale mean, into the digital image signal can be performed by controlling a setting value, which is used for the second ADC 12 to convert the analog image signal into the digital image signal, using the gray scale mean signal inputted to the second ADC 12.

The comb filter 20 is provided as a filter unit for receiving a first digital image signal outputted from the first ADC 11 and a second digital image signal outputted from the second ADC 12 to separate each of the received digital image signals into a brightness signal and a color difference signal. Specifically, the comb filter 20 separates the first digital image signal into which the whole analog image signal is converted, into a brightness signal and a color difference signal. Also, the comb filter 20 separates the second digital image signal into which a portion of the analog image signal corresponding to the luminance lower than the gray scale mean is converted, into a brightness signal and a color difference signal. Then, the comb filter 20 separates a first brightness signal Y1 from the first digital image signal and outputs the first brightness signal Y1 to the histogram analyzer 30, and also separates a second brightness signal Y2 from the second digital image signal and outputs the second brightness signal Y2 to the combining unit 40. Furthermore, the comb filter 20 separates a color difference signal C1 from the first digital image signal and outputs the color difference signal C1 to the signal processing unit 50.

The histogram analyzer 30 serves as a calculation unit for calculating a gray scale mean for an image by analyzing probability density function (PDF) for an image of the first brightness signal Y1 outputted from the comb filter 20. The histogram analyzer 30 can calculate the gray scale mean according to the following Equation 1.
Y_Mean=Mean{Σ(Y_Min, Y_Max)/the number of represented gray scales} Equation 1

Where, Y_Mean is a gray scale mean value corresponding to an image, Y_Min is the minimum gray scale value corresponding to an image, Y_Max is the maximum gray scale value corresponding to an image, and the number of represented gray scales is the number of pixels corresponding to an image. For example, the histogram analyzer 30 adds up gray scale values corresponding to gray scale representation of pixels expressing an image based on the first brightness signal Y1 to calculate a total gray value, and divides the total gray scale value by the number of represented gray scales of the image to calculate the gray scale mean. As a result, the histogram analyzer 30 outputs a gray scale mean signal corresponding to the calculated gray scale mean.

The combining unit 40 plays a role of combining the digital image signals outputted from the first ADC 11 and the second ADC 12 based on the gray scale mean signal outputted from the histogram analyzer 30. The combining unit 40 includes a dithering unit 42 and a mixer 44.

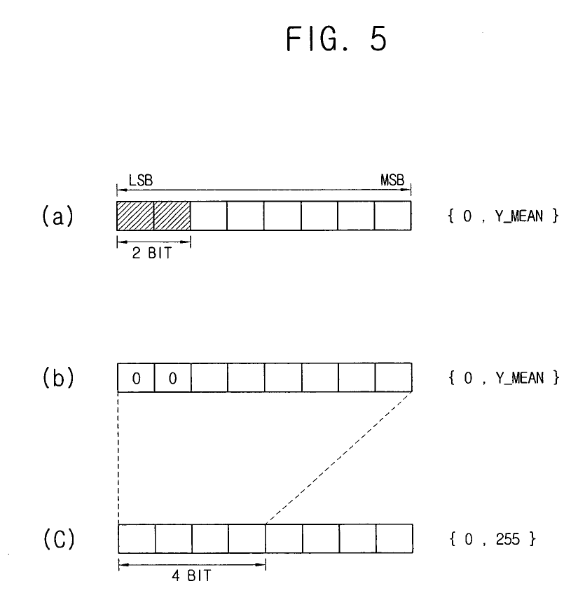

The dithering unit 42 receives the first brightness signal Y1 corresponding to the first digital image signal and the gray scale mean signal from the histogram analyzer 30, and receives the second brightness signal Y2 corresponding to the second digital image signal from the comb filter 20. Furthermore, the dithering unit 42 performs a dithering process on predetermined data in the second brightness signal Y2 based on the gray scale mean signal. For example, as shown in FIG. 5, the dithering unit 42 performs the dithering process to remove the predetermined number (for example, 2 bits) of least significant bits corresponding to a low gray scale portion of the inputted second brightness signal Y2 (of 8 bits, for example) (see FIG. 5(a)) and fill the removed data area (2 bits) with “0” (see FIG. 5(b)). Such a dithering process for the least significant bits is performed because there is a high possibility that an error due to noise may occur in data corresponding to a low gray scale portion. Although the 2-bit dithering process is employed as an example, it is to be understood that a 1-bit or 3-bit dithering process may be employed as another example. As a result, for the second brightness signal Y2, as the low gray scale portion having a high possibility that an error due to noise may occur is dithered, the effect of removing noise in the low gray scale portion can be shown. At this time, it is preferable but not necessary that the dithering unit 42 outputs the first brightness signal Y1 corresponding to the first digital image signal to the mixer 44 without performing a dithering process for the first brightness signal Y1. It should be appreciated that various modifications are possible within the scope of the present invention, including the configuration that the first brightness signal Y1 outputted from the histogram analyzer 30 does not pass through the dithering unit 42 but is directly outputted to the mixer 44.

The mixer 44 combines the first brightness signal (Y1) and the dithered second brightness signal (Y2) into a brightness signal Y. The mixer 44 combines a portion of the first brightness signal Y1 corresponding to the luminance of more than the gray scale means and the second brightness signal Y2 outputted from the dithering unit 42 according to a predetermined look-up table, based on the gray scale mean signal outputted from the histogram analyzer 30. In an exemplary implementation, the look-up table has data for the data area that has to be removed from the first brightness signal Y1, and process data to be used to process the second brightness signal Y2 to produce the brightness signal Y in which the second brightness signal Y2 is written in the data area removed from the first brightness signal (Y1), corresponding to various gray scale mean values. In other words, the look-up table stores data obtained through a variety of simulations for each gray scale mean value to produce the most preferred brightness signal Y by combining the first brightness signal Y1 with the second brightness signal Y2, corresponding to various gray scale mean value.

Accordingly, in combining the dithered second brightness signal Y2 with the first brightness signal Y1 of the first digital image signal, as shown in FIG. 5(b), if the gray scale mean value is determined to be 128 based on the gray scale mean signal, the mixer 44 removes a portion of data (4 bits of a least significant bit (LSB)) corresponding to the luminance lower than the gray scale mean of the 8-bit first brightness signal Y1 of the first digital image signal based on the look-up table, and outputs the brightness signal Y (see FIG. 5(c)) in which the dithered 8-bit second brightness signal Y2 (see FIG. 5(b)) is written in the removed 4 bits of the LSB. Thus, the mixer 44 produces a portion of data (4 bits of the LSB), which corresponds to the luminance lower than the gray scale mean among 0-255 gray scales, as the second brightness signal Y2, and outputs the brightness signal Y (see FIG. 5(c)) in which data (4 bits of a most significant bit (MSB)) corresponding to the luminance higher than the gray scale mean are configured with the data corresponding to the luminance higher than the gray scale mean of the first brightness signal Y1. Here, the data area (4 bits of the LSB) formed of the second brightness signal Y2 of the brightness signal Y outputted by the mixer 44 becomes smaller as the gray scale mean value becomes smaller.

As stated above, the image processing apparatus according to an exemplary embodiment of the present invention includes the second ADC 12 for converting the analog image signal corresponding to the luminance lower than the gray scale mean into the digital image signal based on the gray scale mean value that is calculated by analyzing the brightness signal converted into the digital signal through the first ADC 11, in addition to the first ADC 11. As a result, the image processing apparatus according to an exemplary embodiment of the present invention performs a separate digital conversion for an analog image signal of less than the gray scale mean, that is, corresponding to low gray scales, through the second ADC 12, thereby converting the brightness signal having a low gray scale into a digital signal more minutely.

Therefore, the display device employing the image processing apparatus according to an exemplary embodiment of the present invention displays an image according to the brightness signal Y in which the second brightness signal Y2 having a low gray scale that is converted into a digital signal minutely is combined with a portion of the first brightness signal Y1 having more than gray scale mean, that is, corresponding to a high gray scale, of the whole brightness signal Y1 that is generally converted into a digital signal, thereby overcoming a performance limitation in digital conversion, which may be shown in gray scale representation in converting an analog image signal into a digital image signal, to avoid deterioration of image quality.

In this case, the image processing apparatus according to an exemplary embodiment of the present invention performs the dithering process for the second brightness signal Y2 corresponding to the luminance lower than the gray scale mean that is converted through the second ADC 12, thereby improving quality of an image having a low gray scale that may be particularly prone to be inferior in noise or gray scale representation.

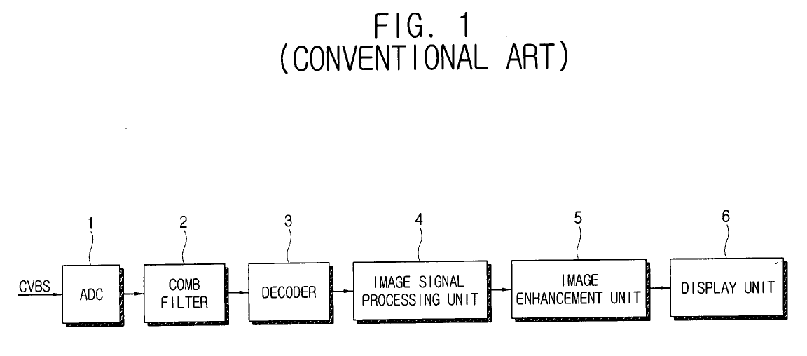

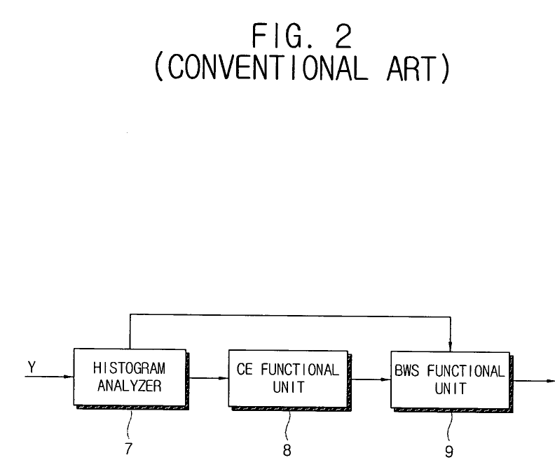

The signal processing unit 50 processes the first color difference signal C1 corresponding to the first digital image signal outputted from the comb filter 20 and the brightness signal Y outputted from the combining unit 40 to make the signals C1 and Y displayable on the display unit 70. In an exemplary implementation, the signal processing unit 50 includes the functions of the decoder 3 (see FIG. 1) and the image signal processing unit 4 (see FIG. 1) in the above-described conventional display device.

The image enhancement unit 60 is a functional unit for performing an enhancing process to improve image quality of an image signal outputted from the signal processing unit 50 based on the gray scale mean signal outputted from the histogram analyzer 30. The image enhancement unit 60 includes a contrast enhancer (CE) functional unit 61 for adjusting the contrast of the brightness signal Y outputted from the signal processing unit 50 based on the gray scale mean signal, a black & white stretch (BWS) functional unit 63 for adjusting a black component of the brightness signal Y based on the gray scale mean signal, and a color signal enhancing unit 65 for improving the image quality of the color difference signal C1 outputted from the signal processing unit 50.

As stated above, an image with improved quality according to the brightness signal Y and the color difference signal C1, which are subjected to the enhancing process through the image enhancement unit 60, is displayed on the display unit 70.

Although the display device including the display unit 70 according to an exemplary embodiment of the present invention has been illustrated in FIGS. 3 and 4 by way of example, it should be appreciated that various modifications may be made without departing from the scope of the present invention, if a display device is an image processing apparatus which can convert an analog image signal into a digital image signal, such as a set-top box without the display unit 70.

As stated above, the display device employing the image processing apparatus according to an exemplary embodiment of the present invention displays an image according to the brightness signal Y in which the second brightness signal Y2 having the low gray scale that is separately converted into the digital signal through the separately provided second ADC 12 is combined with a portion of the first brightness signal Y1 having more than gray scale mean, that is, corresponding to a high gray scale, of the whole brightness signal Y1 that is generally converted into a digital signal. Accordingly, the display device employing the image processing apparatus according to an exemplary embodiment of the present invention can overcome a performance limitation on digital conversion, which may be shown in the gray scale representation in converting an analog image signal into a digital image signal, thereby avoiding deterioration of image quality.

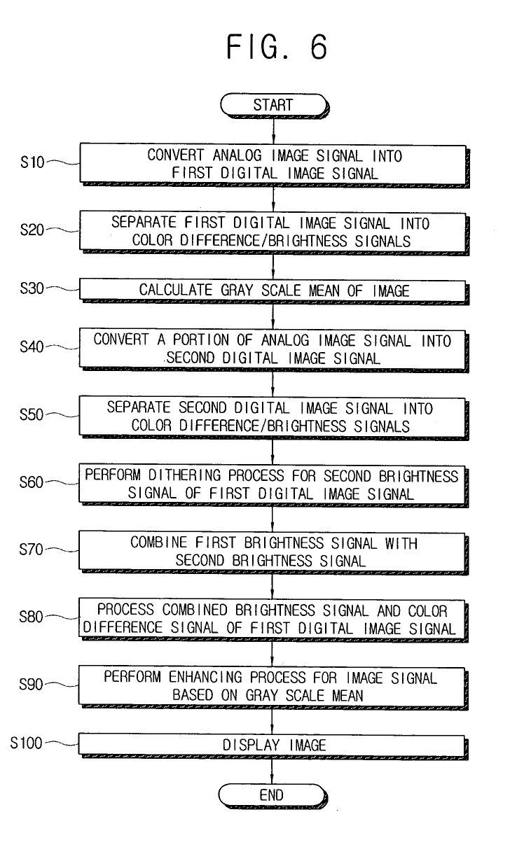

Hereinafter, an image processing method of processing an image signal in the display device employing the image processing apparatus according to an exemplary embodiment of the present invention will be described with reference to FIG. 6.

First, the first ADC 11 converts an inputted analog image signal into a digital image signal at step S10. For example, the first ADC 11 outputs a first digital image signal into which the whole analog image signal corresponding to the whole gray scale of the inputted analog image signal is converted. The comb filter 20 separates the first digital image signal outputted from the first ADC 11 into a brightness signal and a color difference signal at step S20. Furthermore, the comb filter 20 outputs the first brightness signal Y1 separated from the first digital image signal to the histogram analyzer 30, and outputs the color difference signal C1 separated from the first digital image signal to the signal processing unit 50.

Then, the histogram analyzer 30 analyzes probability density function (PDF) for an image according to the first brightness signal Y1 outputted from the comb filter 20 to calculate the gray scale mean for the image at step S30. For example, the histogram analyzer 30 adds up gray scale values corresponding to gray scale representation of pixels expressing an image based on the first brightness signal Y1 to calculate a total gray scale value, and divides the total gray scale value by the number of represented gray scales of the image to calculate the gray scale mean. Then, the histogram analyzer 30 outputs a gray scale mean signal corresponding to the calculated gray scale mean to the second ADC 12. The second ADC 12 converts a portion of the analog image signal into a digital image signal based on the gray scale mean signal outputted from the histogram analyzer 30 at step S40. For example, the second ADC 12 receives the analog image signal as in the first ADC 11, and converts a portion of the analog image signal, which corresponds to the luminance lower than the gray scale mean, into a digital image signal, based on the gray scale mean signal. The comb filter 20 separates the second digital image signal outputted from the second ADC 12 into a brightness signal and a color difference signal at step S50. Furthermore, the comb filter 20 outputs a second brightness signal Y2 separated from the second digital image signal to the combining unit 40.

The combining unit 40 performs a dithering process for the second brightness signal Y2 based on the gray scale mean signal outputted from the histogram analyzer 30 at step S60. At this time, the combining unit 40 does not perform a dithering process for the first brightness signal Y1. Furthermore, the combining unit 40 combines the first brightness signal Y1 and the dithered second brightness signal Y2 into a brightness signal Y at step S70. For example, the combining unit 40 combines a portion of the first brightness signal Y1 corresponding to the luminance higher than the gray scale mean and the second brightness signal Y2 outputted from the dithering unit 42, based on the gray scale mean signal outputted from the histogram analyzer 30, according to a predetermined look up table.

As stated above, in the image processing method according to an exemplary embodiment of the present invention, in addition to the conversion of the whole analog image signal into the digital image signal, a portion of the analog image signal corresponding to the luminance lower than the gray scale mean is converted into a digital image signal, based on the gray scale mean value that is calculated by analyzing the brightness signal converted into a digital signal through the first ADC 11. As a result, the image processing method according to an exemplary embodiment of the present invention performs a separate digital conversion for an analog image signal of less than the gray scale mean, that is, corresponding to low gray scales, thereby converting the brightness signal having a low gray scale into a digital signal more minutely.

Thereafter, at step S80, the signal processing unit 50 processes the brightness signal Y produced in the combining unit 40 and the color difference signal C1 separated from the first digital image signal at step S20 to be displayed on the display unit 70. Furthermore, the image enhancement unit 60 performs an enhancing process to improve the image quality of an image signal outputted from the signal processing unit 50, based on the gray scale mean signal outputted from the histogram analyzer 30 at step S90. Such an enhancing process may include a process of adjusting the contrast of the brightness signal Y outputted from the signal processing unit 50 based on the gray scale mean signal, and a process of adjusting the black component of the brightness signal Y based on the gray scale mean signal. Furthermore, an image with improved quality according to the brightness signal Y and the color difference signal C1, which are subjected to the enhancing process through the image enhancement unit 60, is displayed on the display unit 70 at step S100.

As stated above, in the image processing method according to exemplary embodiments of the present invention, an image according to the brightness signal Y in which the second brightness signal Y2 having a low gray scale that is converted into a digital signal through the separately provided second ADC 12 is combined with a portion of the first brightness signal Y1 higher than the gray scale mean, that is, corresponding to a high gray scale, of the whole brightness signal Y1 that is generally converted into a digital signal. Accordingly, the image processing method can improve a performance limitation on digital conversion, which may be shown in the gray scale representation in converting an analog image signal into a digital image signal, thereby avoiding deterioration of image quality. As apparent from the above description, exemplary embodiments of the present invention provides an image processing apparatus and a method thereof for providing improved gray scale representation signal by performing an adaptive process to convert an analog image signal into a digital image in consideration of gray scales of the analog image signal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An image processing apparatus including a signal input unit to which an analog image signal is inputted, the apparatus comprising:
a first conversion unit for converting an analog image signal inputted through the signal input unit into a first digital image signal;
a calculating unit for calculating a gray scale mean for an image by analyzing a brightness signal of the first digital image signal outputted from the first conversion unit, and outputting a gray scale mean signal corresponding to the calculated gray scale mean;
at least one second conversion unit for converting a portion of the analog image signal into a second digital image signal based on the gray scale mean signal; and
a combining unit for combining the first digital image signal and the second digital image signal based on the gray scale mean signal.

2. The image processing apparatus according to claim 1, further comprising a filtering unit for receiving the first digital image signal outputted from the first conversion unit and the second digital image signal outputted from the second conversion unit, and separating the received first and second digital image signals into a brightness signal and a color difference signal.

3. The image processing apparatus according to claim 2, wherein the calculating unit calculates the gray scale mean for the image by analyzing the brightness signal, which corresponds to the first digital image signal, of the brightness signal and the color difference signal in each of the first and second digital image signals outputted from the filtering unit, and outputs the gray scale mean signal corresponding to the calculated gray scale mean.

4. The image processing apparatus according to claim 3, wherein the calculating unit calculates a total gray scale value by adding up gray scale values for gray scale representation expressing the image, based on the brightness signal of the first digital image signal, and calculates the gray scale mean by dividing the total gray scale values by the number of represented gray scales of the image.

5. The image processing apparatus according to claim 2, wherein the second conversion unit converts a portion of the analog image signal inputted through the signal input unit, the portion corresponding to the luminance lower than the gray scale mean, into the second digital image signal, based on the gray scale mean signal.

6. The image processing apparatus according to claim 5, wherein the combining unit includes a dithering unit for performing a dithering process for reference data in the brightness signal of the second digital image signal based on the gray scale mean signal, and a mixer for combining a portion of the brightness signal of the first digital image signal, the portion corresponding to the luminance higher than the gray scale mean, with the brightness signal of the second digital image signal outputted from the dithering unit based on the gray scale mean signal and a look-up table.

7. The image processing apparatus according to claim 6, further comprising:
a signal processing unit for processing the color difference signal corresponding to the first digital image signal outputted from the filtering unit and the brightness signal outputted from the combining unit into a displayable image signal; and
an image enhancement unit for improving image quality of an image signal outputted from the signal processing unit.

8. The image processing apparatus according to claim 7, wherein the image enhancement unit performs a process for improving the image quality of the image signal outputted from the signal processing-unit based on the gray scale mean signal outputted from the calculating unit.

9. The image processing apparatus according to claim 8, wherein the image enhancement unit comprises a contrast enhancer (CE) functional unit for adjusting contrast of the image signal outputted from the signal processing unit based on the gray scale mean signal, and a black & white stretch (BWS) functional unit for adjusting a black component of the image signal outputted from the signal processing unit.

10. The image processing apparatus according to claim 9, wherein the first conversion unit and the second conversion unit comprises an analog-to-digital converter (ADC) for converting the analog image signal into the digital image signal.

11. The image processing apparatus according to claim 1, further comprising a display unit for displaying an image according to the digital image signal outputted from the combining unit.

12. The image processing apparatus according to claim 4, wherein the second conversion unit converts a portion of the analog image signal inputted through the signal input unit, the portion corresponding to the luminance lower than the gray scale mean, into the second digital image signal, based on the gray scale mean signal.

13. An image processing method for an image signal processing apparatus including a signal input unit to which an analog image signal is inputted, the method comprising:
converting an analog image signal inputted through the signal input unit into a first digital image signal;
calculating a gray scale mean for an image by analyzing a brightness signal of the first digital image signal, and outputting a gray scale mean signal corresponding to the calculated gray scale mean;
converting a portion of the analog image signal inputted through the signal input unit into a second digital image signal based on the gray scale mean signal; and
combining the first digital image signal and the second digital image signal based on the gray scale mean signal.

14. The image processing method according to claim 13, further comprising:
separating the first digital image signal into a brightness signal and a color difference signal; and
separating the second digital image signal into a brightness signal and a color difference signal.

15. The image processing method according to claim 14, wherein the outputting of the gray scale mean comprises:
calculating a total gray scale value by adding up gray scale values for gray scale representation expressing the image, based on the brightness signal of the first digital image signal;
calculating the gray scale mean by dividing the total gray scale values by the number of represented gray scales of the image; and
outputting the calculated gray scale mean signal.

16. The image processing method according to claim 15, wherein the converting of the portion of the analog image signal into the second digital image signal comprises converting a portion of the analog image signal inputted through the signal input unit, the portion corresponding to the luminance lower than the gray scale mean, into the second digital image signal, based on the gray scale mean signal.

17. The image processing method according to claim 16, wherein the combining the first digital image signal and the second digital image signal comprises:
performing a dithering process for reference data in the brightness signal of the second digital image signal based on the gray scale mean signal; and
combining a portion of the brightness signal of the first digital image signal, the portion corresponding to the luminance higher than the gray scale mean, with the brightness signal of the dithered second digital image signal based on the gray scale mean signal and a look-up table.

18. The image processing method according to claim 17, further comprising:
processing the color difference signal separated from the first digital image signal and a mixed brightness signal produced by a mixture of the brightness signal of the first digital image signal and the brightness signal of the second digital image signal, into a displayable image signal; and
improving image quality of the displayable image's image signal.

19. The image processing method according to claim 18, wherein the improving of the image quality of the displayable image signal comprises improving the image quality of the displayable image signal based on the gray scale mean signal.

20. The image processing method according to claim 19, wherein the improving of the image quality of the displayable image comprises:
adjusting contrast of the displayable image signal based on the gray scale mean signal; and
adjusting a black component of the displayable image signal.

21. The image processing method according to claim 13, further comprising displaying an image according to a mixed digital image signal produced by a mixture of the first digital image signal and the second digital signal.

22. An image processing apparatus including a signal input unit to which an analog image signal is inputted, the apparatus comprising:
a first conversion unit for converting an analog image signal inputted through the signal input unit into a first digital image signal;
a calculating unit for calculating a gray scale mean for an image by analyzing a brightness signal of the first digital image signal outputted from the first conversion unit, and outputting a gray scale mean signal corresponding to the calculated gray scale mean; and
a second conversion unit for converting a portion of the analog image signal into a second digital image signal based on the gray scale mean signal; and

23. The image processing apparatus of claim 22 further comprising a combining unit for combining the first digital image signal and the second digital image signal based on the gray scale mean signal.

24. The image processing apparatus according to claim 22, further comprising a filtering unit for receiving the first digital image signal outputted from the first conversion unit and the second digital image signal outputted from the second conversion unit, and separating the received first and second digital image signals into a brightness signal and a color difference signal.

25. The image processing apparatus according to claim 23, wherein the combining unit includes a dithering unit for performing a dithering process for reference data in the brightness signal of the second digital image signal based on the gray scale mean signal, and a mixer for combining a portion of the brightness signal of the first digital image signal, the portion corresponding to the luminance higher than the gray scale mean, with the brightness signal of the second digital image signal outputted from the dithering unit based on the gray scale mean signal and a look-up table.

26. The image processing apparatus according to claim 25, further comprising:
a signal processing unit for processing the color difference signal corresponding to the first digital image signal outputted from the filtering unit and the brightness signal outputted from the combining unit into a displayable image signal; and
an image enhancement unit for improving image quality of an image signal outputted from the signal processing unit.

27. The image processing apparatus according to claim 22, further comprising a display unit for displaying an image according to the digital image signal outputted from the combining unit.
